(19) United States
(12) Patent Application Publication
(10) Pub. No.: US 2016/0048922 A1
(43) Pub. Date: Feb. 18, 2016

(54) ETF RESEARCH PLATFORM

(71) Applicant: BANK OF AMERICA CORPORATION, CHARLOTTE, NC (US)

(72) Inventor: Steven K. Stearns, Fairfield, CT (US)

(21) Appl. No.: 14/462,162

(22) Filed: Aug. 18, 2014

(51) Int. Cl. G06Q 40/06

(52) U.S. Cl. CPC G06Q 40/06; G06Q 40/04

(57) ABSTRACT

Disclosed is an exchange traded fund (ETF) research system. The ETF research system typically includes a processor, a memory, and a scoring module stored in the memory. The scoring module is typically configured for determining a first score of each of a plurality of exchange traded fund according to a first multifactor model; based on the first score of each exchange traded fund, determining a first percentile ranking of each exchange traded fund relative to the plurality of exchange traded funds; determining a first percentile ranking for each of a plurality of asset class categories; and graphically presenting a first user interface including a numeric representation and a color representation of the first percentile ranking of one or more of the asset class categories.

### FIELD OF THE INVENTION

The present invention embraces an exchange traded fund (ETF) research system. The ETF research system typically includes a processor, a memory, and a scoring module stored in the memory. The scoring module is typically configured for: determining a first score of each of a plurality of exchange traded funds according to a first multifactor model; determining a first percentile ranking of each exchange traded fund relative to the plurality of exchange traded funds; determining a first percentile ranking for each of a plurality of asset class categories; and graphically presenting a first user interface including a numeric representation and a color representation of the first percentile ranking of one or more of the asset class categories.

### BACKGROUND

Traditionally, an investor in securities has had to choose between an actively managed portfolio in which investments are actively selected to seek a return that outperforms of the market and a passively-managed portfolio in which investments mirror one or more standard market indexes based on market capitalization. Recently, a third investment style, smart beta investing has become more popular. Smart beta investing combines aspects of active and passive portfolio management. Instead of seeking to mirror a standard market index, smart beta investing employs a strategy based on one or more factors in an effort to seek a return and/or reduce volatility in comparison with standard market indexes. For example, a smart beta strategy might weight or screen a standard market index based on one or more factors, such as cash flow, dividends, or volatility. Once the rules for the strategy have been defined, these rules are passively followed.

Recently, the popularity of exchange traded funds (ETFs) has also grown. Exchange traded funds are similar to mutual funds and allow investors to invest in a bundle of assets. Unlike mutual funds, however, exchange traded funds can be bought and sold throughout the day. As compared with mutual funds, there may be higher or lower costs associated with investing in mutual funds depending on the circumstances. Most exchange traded funds are index funds that seek to mirror a standard mark index. That said, a growing number of exchange traded funds employ active or smart beta investing strategies.

With the growth of exchange traded funds, a need exists for an improved way of evaluating and comparing exchange traded funds.

### SUMMARY

In one aspect, the present invention embraces an ETF research system and an associated method and computer program product. The ETF research system typically includes a non-transitory computer-readable storage medium and at least one computer processor. The ETF research system also typically includes an ETF scoring module stored in the memory and executable by the computer processor.

In one embodiment, the ETF scoring module includes computer-executable instructions for causing the computer processor to be configured for: determining the asset allocation of each exchange traded fund, each exchange traded fund holding one or more constituent holdings; retrieving factor data regarding each constituent holding; based on the retrieved factor data and the asset allocation for each exchange traded fund, determining a first score of each exchange traded fund according to a first multifactor model; based on the first score of each exchange traded fund, determining a first percentile ranking of each exchange traded fund relative to the plurality of exchange traded funds; determining a first percentile ranking for each of a plurality of asset class categories, wherein determining the first percentile ranking for each asset class category comprises determining an average of the first percentile rankings of each exchange traded fund associated with such asset class category; and graphically presenting a first user interface for display on the user device, the first user interface including a numeric representation and a color representation of the first percentile ranking of one or more of the asset class categories.

In a particular embodiment, the ETF scoring module includes computer-executable instructions for causing the computer processor to be configured for: receiving a selection of one of the asset class categories from the user device; and, based on the selection of one of the asset class categories, graphically presenting a second user interface for display on the user device, the second user interface including a numeric representation and a color representation of the first percentile ranking of each exchange traded fund associated with the selected asset class category.

In another particular embodiment, the ETF scoring module includes computer-executable instructions for causing the computer processor to be configured for: based on the retrieved factor data and the asset allocation for each exchange traded fund, determining a second score of each exchange traded fund according to a second multifactor model; based on the second score of each exchange traded fund, determining a second percentile ranking of each exchange traded fund relative to the plurality of exchange traded funds; and determining a second percentile ranking for each of the plurality of asset class categories, wherein determining the second percentile ranking for each asset class category comprises determining an average of the second percentile rankings of each exchange traded fund associated with such asset class category; wherein the first user interface includes a numeric representation and a color representation of the second percentile ranking of one or more of the asset class categories.

In another particular embodiment, the ETF scoring module includes computer-executable instructions for causing the computer processor to be configured for: receiving a user selection from the user device; and, based on the user selection received from the user device, graphically presenting a second user interface for display on the user device, the second user interface including a numeric representation and a color representation of the first percentile ranking of each exchange traded fund associated with a plurality of asset class categories.

In another particular embodiment, the ETF scoring module includes computer-executable instructions for causing the computer processor to be configured for: continuously retrieving updated factor data regarding each constituent holding; and based on the updated factor data, continuously updating (i) the first score of each exchange traded fund, (ii) the first percentile ranking of each exchange traded fund, and (iii) the first percentile ranking for each asset class category.

In another particular embodiment, the asset class categories included in the first user interface are included in the first user interface based on a user selection received from the user device.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 depicts a method of scoring a plurality of exchange traded funds according to one or more multifactor model and presenting the scores of the exchange traded funds to a user device via one or more user interfaces in accordance with an aspect of the present invention;

FIG. 2 depicts an exemplary graphical user interface displaying the percentile rankings of a plurality of asset class categories in accordance with an embodiment of the present invention;

FIG. 3 depicts an exemplary graphical user interface displayed based on a user selection of a particular asset class category in accordance with an embodiment of the present invention;

FIG. 4 depicts an exemplary graphical user interface in accordance with another embodiment of the present invention;

FIG. 5 depicts an exemplary graphical user interface in accordance with yet another embodiment of the present invention;

FIGS. 6A-6B depict an exemplary graphical user interface in accordance with a further embodiment of the present invention;

FIG. 7 depicts an ETF research system and operating environment in accordance with an aspect of the present invention; and

FIG. 8 schematically depicts an ETF research system in accordance with an aspect of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by an entity. In other embodiments, an “entity” may not be a financial institution.

In some embodiments, the “user” may be a customer (e.g., an account holder or a person who has an account (e.g., banking account, credit account, brokerage account or the like) at the entity) or potential customer (e.g., a person who has submitted an application for an account, a person who is the target of marketing materials that are distributed by the entity, a person who applies for a loan that not yet been funded). In other embodiments, the “user” may refer to an employee of the entity.

In one aspect, the present invention generally relates to an ETF research system that scores exchange traded funds (ETFs) according to one or more multifactor models and presents the scores of the exchange traded funds via one or more user interfaces. In scoring the ETFs, the system first retrieves factor data regarding the individual assets held in each ETF (i.e., each ETF's constituent holdings). By using factor data regarding the individual assets in each ETF for scoring, ETFs can be more consistently compared against one another. In this regard, the user interfaces provided by the ETF research system enable a user to readily compare ETFs and categories of ETFs against each other and locate ETFs and categories of ETFs favorable to an investing strategy employed by the user. In addition, by continuously processing vast amounts of factor data, the present system enables users to quickly and consistently identify investing opportunities, which would be difficult to achieve by manually sorting through such factor data.

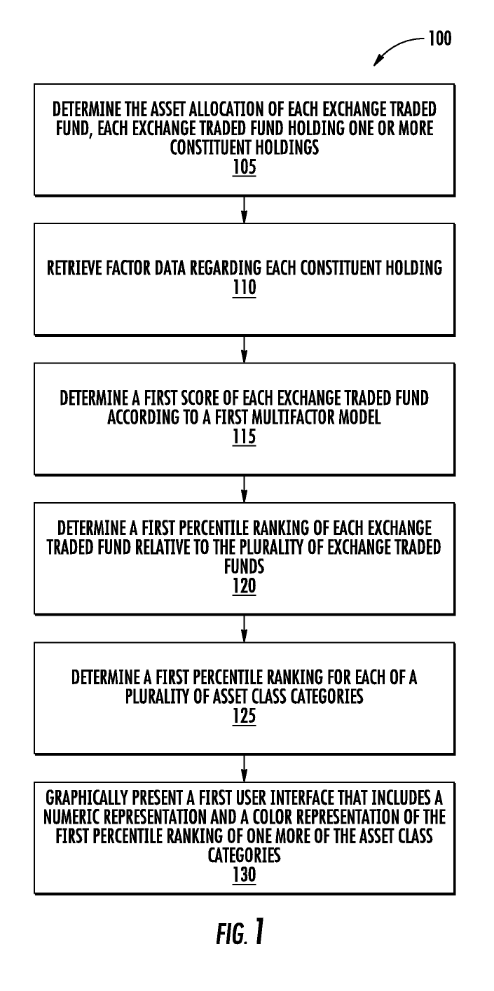

Accordingly, FIG. 1 depicts a method 100 of scoring a plurality of exchange traded funds according to one or more multifactor model and presenting the scores of the exchange traded funds to a user device via one or more user interfaces in accordance with an aspect of the present invention.

First, at block 105, the asset allocation of each exchange traded fund (ETF) is determined, typically by an ETF research system provided by a financial institution. Each ETF typically includes a number of different constituent holdings (e.g., different stocks, bonds, real estate holdings, commodities, currencies, and/or cash). In some embodiments, some of the ETFs may include the same class of assets (e.g., equities, bonds, or real assets). In some embodiments, some of the ETFs may include constituent holdings of the same class category, such as equities or bonds that relate to the same country, region, size (e.g., small, medium, or large), style (e.g., value or growth), or sector (e.g., staples, healthcare, telecomm, utilities, financials, technology, industrial, materials, and the like). In other embodiment, the ETFs may relate to differing asset classes and/or asset class categories. The assets (i.e., constituent holdings) held by the ETF may be held in equal or unequal proportions. For example, one ETF may hold 20 stocks with the stocks being held in equal proportions. By way of further example, another ETF may hold numerous stocks in varying proportions that reflect a market-capitalization-weighted standard stock market index. Accordingly, the asset allocation for each ETF includes the proportion of each asset held by each ETF. Information necessary to determine the asset allocation of each ETF is typically retrieved from one or more ETF databases, which may be maintained by the financial institution or by a third party data provider. Because the holdings of ETFs often change over time (e.g., due to decisions by active managers or due to a change in the makeup of an underlying market index), such ETF databases may be regularly updated to ensure that up to date information regarding each ETF can be retrieved.

At block 110, factor data regarding each constituent holding (e.g., each stock and/or bond held by each ETF) is retrieved. This factor data typically includes financial data, financial ratios, and/or other metrics regarding each constituent holding. By way of example, such factor data may include various metrics such as price, earnings, cash flow, market capitalization, volatility, price to earnings, price to book value, dividend yield, and the like. In some instances, such factor data may include rankings, projections, and/or recommendations from analysts. Typically, the factor data for each constituent holding includes a score or data related to one or more smart beta factors. Such beta factors may include value, momentum, quality, capital stewardship (e.g., yield or growth), and/or trend strength. Factor data related to the value beta factor may include: intrinsic value, relative value, price to book, price to earnings, price to cash flow, price to sales, and projected total return. Factor data related to the momentum beta factor may include: trailing total return, composite price momentum, and analyst revision momentum. Factor data related to the quality beta factor may include: return on capital, return on equity, earnings quality, and beta. Factor data related to the capital stewardship beta factor may include: shareholder yield, dividend year, buyback yield, dividend growth, historical dividend growth, projected dividend growth, dividend quality, and projected earnings growth. Factor data related to the trend strength beta factor may include various technical indicators. In some embodiments, the factor data may be retrieved from one or more factor databases, which may be maintained by the financial institution or by a third party data provider. Because some of the metrics (e.g., the market price of constituent holdings) may be constantly changed, such factor databases may be constantly updated (e.g., in real time), and, accordingly, updated factor data may be continuously retrieved from such factor databases. In other embodiments, the ETF research system may be in communication with one or more factor data feeds, which may be provided by the financial institution or by a third party data provider. Such factor feeds may provide live (e.g., real time) factor data.

Based on the retrieved factor data and the asset allocation of each exchange traded fund, at block 115, a first score of each exchange traded fund in accordance with a first multifactor model is determined. The first multifactor model incorporates a number of factors to evaluate the efficacy of investing in a particular asset, typically over a defined time horizon. For example, the first multifactor model may be (i) a short term (e.g., 0-6 month investment time horizon) dynamic model that heavily weights the momentum beta factor, (ii) an intermediate term (e.g., 6-24 month investment time horizon) tactical model that utilizes value and momentum beta factors, (iii) a long term (e.g., 1-5 year investment time horizon) strategic model that heavily weights the value beta factor, (iv) a long term (e.g., 3-5 year investment time horizon) income model that heavily weights the income beta factor, and (v) a long term (e.g., 3-5 year investment time horizon) core model that utilizes quality and value beta factors. In order to determine the score of a particular ETF in accordance with the first multifactor model, factor data for each constituent holding held by the ETF is aggregated and weighted in accordance with the ETF's asset allocation. The first multifactor model may also incorporate any fees associated with owning the ETF as well as any transaction costs (e.g., to take into the account the bid-offer spread for the ETF). In some embodiments, the multifactor models are static (i.e., do not change). That said, in other embodiments, one or more multifactor models might be dynamically altered based on changing conditions or user preferences. For example, weighting assigned to different factors employed in a particular model may change depending on changing market conditions.

Next, at block 120, using the first score of each exchange traded fund, a first percentile ranking of each exchange traded fund is determined. In this regard, the first score of each ETF is compared against the first scores of other ETFs to determine a relative percentile ranking for each ETF. Typically, the first score of each ETF is compared against the first scores of all other ETFs regardless of the asset classes or class categories to which the ETFs relate (e.g., the first score of an equity ETF would be compared against the first scores of all other ETFs holding equities, bonds, real assets, and other classes of assets) to determine the first percentile ranking. That said, in some embodiments, the first score of each ETF is compared against the first scores of all other ETFs related to the same asset class (e.g., the first score of an equity ETF would be compared against the first scores of all other ETFs holding equities, but not ETFs holding other types of assets such as bonds, real assets, and other classes of assets). In this regard, in some instances a particular multifactor model may only be applicable to a particular asset class.

At block 125, a first percentile ranking for each of a plurality of asset class categories is determined. In this regard, the first percentile ranking for a particular asset class category (e.g., large value U.S. equities) is typically the average (e.g., mean, median, truncated mean, or truncated median) of the first percentile rankings for all of the ETFs related to the particular asset class category. An ETF is related to or associated with an asset class category if the holdings of the ETF substantially (but not necessarily entirely) fall within the asset class category. For example, if the asset class category were U.S. defensive equities, this asset class category would include any ETF primarily holding U.S. equities classified as defensive (e.g., U.S. defensive stocks making up 80 or 90 percent of its holdings). This asset class category would also include any ETF primarily holding U.S. equities within a particular technology section classified as defensive (e.g., U.S. utility stocks making up 80 or 90 percent of its holdings). That said, this asset class category would not include an ETF where U.S. defensive stocks made up 50 percent of its holding and European defensive stocks made up 50 percent of its holdings, although such an ETF could be classified under an asset class category for global defensive equities.

The steps represented by blocks 115-125 may then be repeated for additional multifactor models. For example, if the first multifactor model relates to a short term dynamic model, these steps may be repeated for an intermediate term tactical model and for a long term strategic model. That said, in some instances a multifactor model might not be application to all asset classes. Accordingly, a percentile ranking under such a multifactor model might not be determined for some ETFs.

At block 130, a first graphical user interface is graphically presented for display (e.g. on a user device). The first user interface typically includes a numeric representation and color representation of the percentile ranking(s) of one of more asset class categories. For example, the user interface may depict various categories (e.g., categories based on country, region, size, style or sector) of one of more asset class categories, such as equities or bonds. The categories included in the first graphical user interface may be based on user selection. For example, a user may indicate (e.g., by pressing a corresponding button presented via a user interface) that the user wants to see asset class categories related to (i) one or more particular asset classes, (ii) a particular asset class within a particular region (e.g., country), or (iii) a particular asset class within different regions. Each displayed asset class category typically includes a numeric representation of the percentile ranking of that asset class category with respect to a particular multifactor model. In some embodiments, the first graphical user interface includes the percentile rankings of each asset class category with respect to multiple multifactor models. In some embodiments, a user may select one or more multifactor models from which percentile rankings will be included in the first graphical user interface. The first graphical user interface also typically includes a color representation (e.g., an indicator) of the same percentile ranking for each displayed asset class category. For example, indicators of the percentile ranking of displayed asset class categories may transition been a first color hue (e.g., green) and a second color hue (e.g., red), wherein the respective proportions of each color hue is based on percentile ranking. By way of further example, a percentile ranking of 100 may include 100 percent of the first color hue and 0 percent of the second color hue, a percentile ranking of 50 may include 50 percent of the first color hue and 50 percent of the second color hue, and a percentile ranking of 0 may include 0 percent of the first color hue and 100 percent of the second color hue. In other embodiments, indicators of the percentile ranking of displayed asset class categories may transition been lighter and darker colors (e.g., between light gray and dark gray) based on percentile ranking. In some embodiments, the first graphical user interface may include percentile rankings of the asset class categories of multiple multifactor models.

The first graphical user interface typically allows the user to select one of the displayed asset class categories in order to acquire additional information regarding that asset class category. In this regard, once a selection of one of the asset class categories has been received (e.g., from a user device), a second graphical user interface is graphically presented for display (e.g. on a user device). This second graphical user interface typically includes information regarding each of the ETFs associated with the selected asset class category. In this regard, the second graphical user interface includes a numeric representation and a color representation of the percentile ranking of each ETF associated with the selected asset class category with respect to the same multifactor model as the selected asset class category. In addition to each ETF's percentile ranking with respect to this multifactor model, the second graphical user interface may also include percentile rankings with respect to other multifactor models, factor data and/or corresponding rankings of the ETFs based on such factor data.

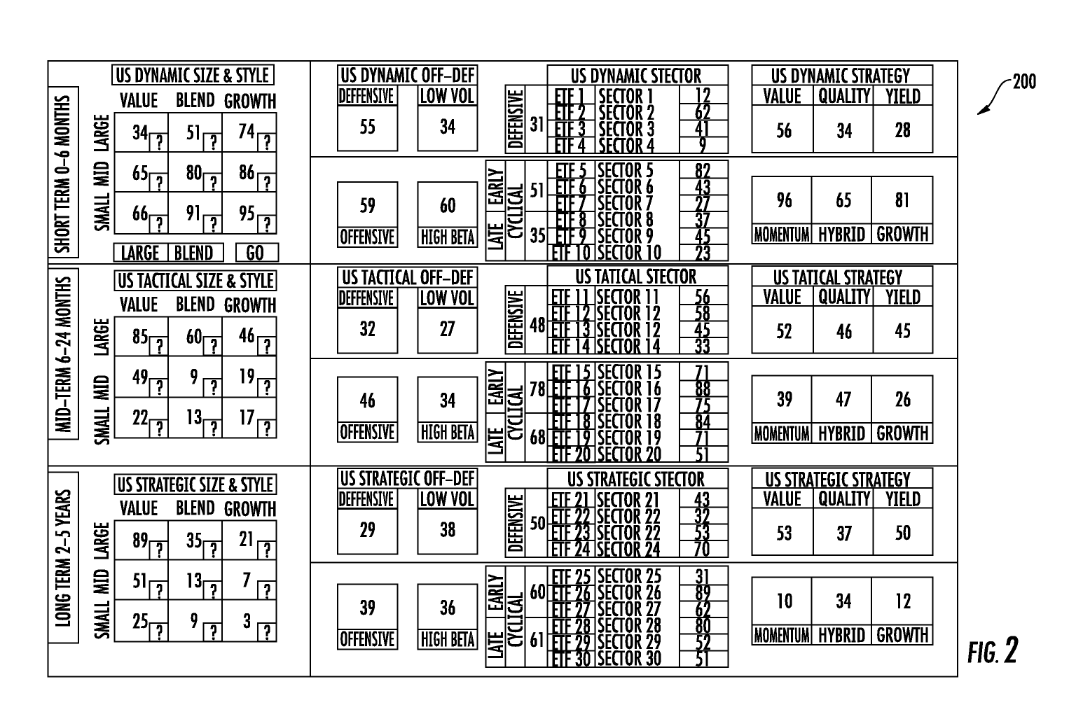

FIG. 2 depicts an exemplary first graphical user interface 200 displaying the percentile rankings of a plurality of asset class categories. In particular, the first graphical user interface 200 displays the percentile rankings of a plurality of asset class categories relevant to US equities with respect to three different multifactor models, namely a dynamic model, a tactical model, and a strategic model. The first graphical user interface 200 may be presented based on user selection (e.g., a user selecting a button for “U.S. Equities”). As displayed in FIG. 2, the top portion of the first graphical user interface 200 includes percentile rankings for asset class categories with respect to the dynamic model, the middle portion of the first graphical user interface 200 includes percentile rankings for asset class categories with respect to the tactical model, and bottom portion of the first graphical user interface 200 includes percentile rankings for asset class categories with respect to the strategic model. The left most column of the first graphical user interface 200 includes asset class categories based on size and style. The second to the left column of the first graphical user interface 200 includes asset class categories based on the offensive or defensive nature of the associated ETFs. The second to the right column of the first graphical user interface 200 includes asset class categories based on sector. The right most column of the first graphical user interface 200 includes asset class categories based on certain smart beta factors. Each asset class category includes a percentile ranking based on each of the multifactor models. These percentile rankings may be displayed numerically and based on color, namely with the highest score being dark green, the lowest scores being dark red, and intermediate scores being a proportionate blend of green and red. Each asset class category is typically selectable by the user. In this regard, the asset class categories of the first graphical user interface 200 may include corresponding buttons that can be selected by the user.

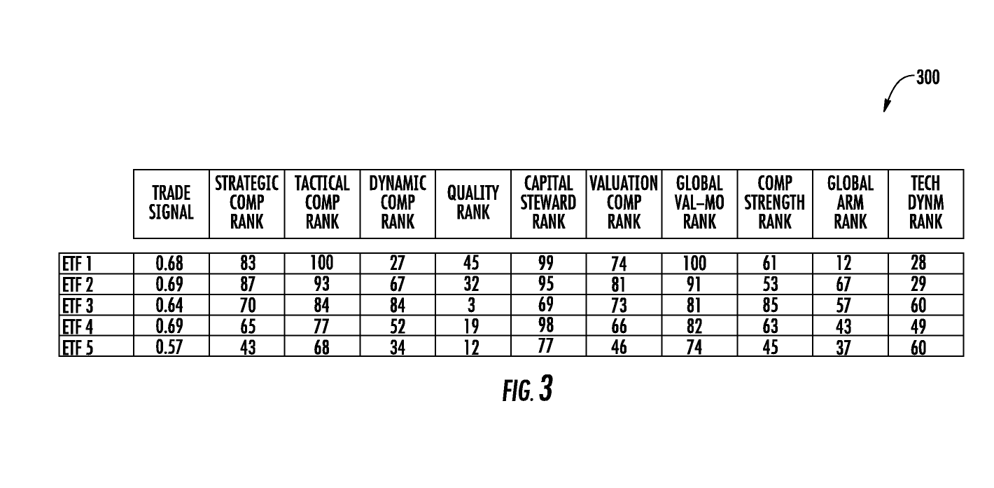

After a particular asset class category has been selected by a user, a second graphical user interface, which includes information regarding each of the ETFs associated with the selected asset class category, may be displayed. In this regard, FIG. 3 depicts a second graphical user interface 300 based on a user selection of large, value equities under the tactical multifactor model. As depicted in FIG. 3, the second graphical user interface 300 includes a list of each ETF associated with the large, value equities asset class category. The second graphical user interface 300 includes the percentile rankings of the ETFs based on the tactical multifactor model. The second graphical user interface 300 also includes the percentile rankings of the ETFs based on the strategic and dynamic multifactor models. Furthermore, the second graphical user interface 300 includes the percentile ranking of the ETFs based on scores for certain smart beta factors. As depicted in FIG. 3, the ETFs may be sorted based on the multifactor model under which the asset class category was selected. In a particular embodiment, each ETF may be further selectable by a user, where selecting a particular ETF results in the display of a further graphical interface that depicts the allocation of the ETF's constituent holdings.

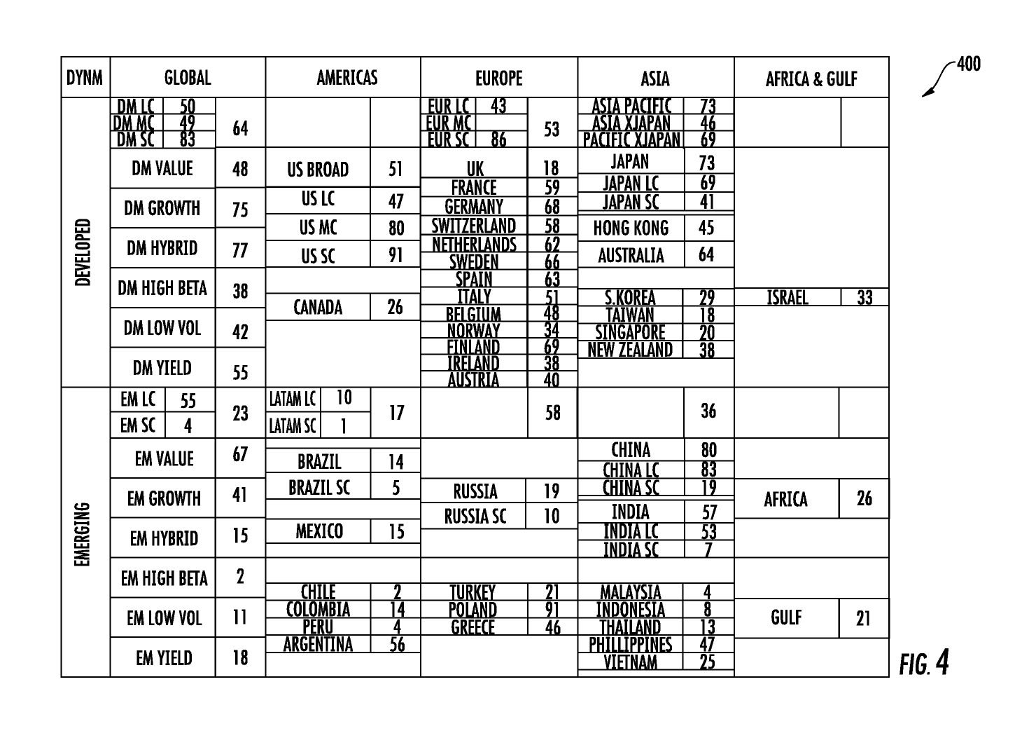

FIG. 4 depicts another graphical user interface 400 that is based on geographic region. The graphical user interface 400 may be presented based on user selection (e.g., a user selecting a button for “Equities—Dynamic—By Region”). In particular, this graphical user interface 400 includes percentile rankings for region/country-based asset class categories relevant to equities under the dynamic multifactor model. As depicted in FIG. 4, the top half of the graphical user interface 400 relates to equities from developed markets and bottom half of the graphical user interface 400 relates to equities from emerging markets. The left most column includes various non-regional asset class categories related to global (i.e., all) equities. For example, the “DM LC” asset class category, includes all large cap ETFs from developed markets. The remaining columns include asset class categories particular to certain regions and countries. Each asset class category is typically selectable by the user. Based on such selection, another graphical user interface, which includes information regarding each of the ETFs associated with the selected asset class category, may be displayed.

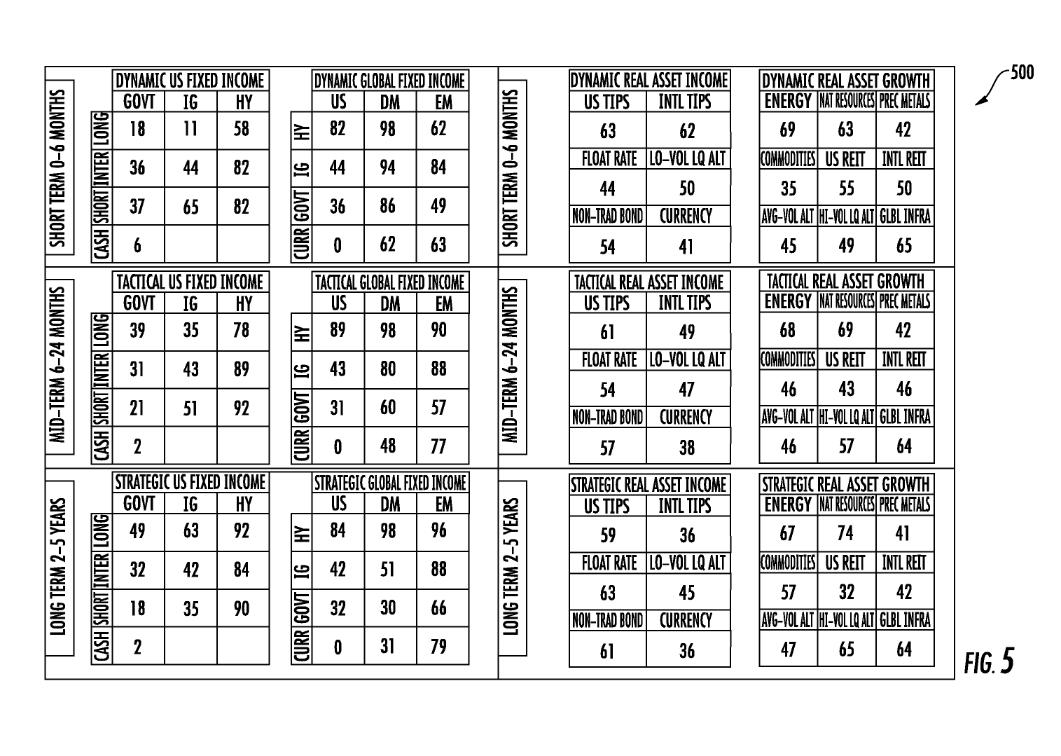

FIG. 5 depicts another graphical user interface 500 displaying the percentile rankings of a plurality of asset class categories relevant to fixed income (e.g., bonds) and real and alternative asset classes (e.g., involving real estate, commodities, natural resources, precious metals, non-traditional and/or liquid alternative funds) with respect to three different multifactor models, namely a dynamic model, a tactical model, and a strategic model. The graphical user interface 500 may be presented based on user selection (e.g., a user selecting a button for “Fixed Income/Real Assets”). As displayed in FIG. 5, the top portion of the first graphical user interface 500 includes percentile rankings for asset class categories with respect to the dynamic model, the middle portion of the first graphical user interface 500 includes percentile rankings for asset class categories with respect to the tactical model, and bottom portion of the first graphical user interface 500 includes percentile rankings for asset class categories with respect to the strategic model. The left most column includes asset class categories related to the U.S. fixed income based on term (e.g., short, intermediate, and long term maturities) and type (e.g., government, investment grade, or high yield). The second from the left column includes asset class categories related to the global fixed income based on region (e.g., U.S., developed markets, and emerging markets) and type (e.g., government, investment grade, or high yield). The second from the right column includes asset class categories related to income-oriented (low volatility) real and alternative assets of various types, such as U.S. treasury inflation-protected securities, international treasury inflation-protected securities, floating rate bonds, non-traditional bonds, low volatility liquid alternative investments, and currency. The right most column includes asset class categories related to growth-oriented (higher volatility) real and alternative assets based the type of real asset, such as U.S. real estate investment trusts, international real estate investment trusts, infrastructure, natural resources (e.g., equities related to natural resources), energy (e.g., energy-related equities), commodities, precious metals, average volatility alternative investments, and high volatility alternative investments. ETFs that are alternative investments seek to replicate alternative strategies often employed by hedge funds and some mutual funds. Each asset class category is typically selectable by the user. Based on such selection, another graphical user interface, which includes information regarding each of the ETFs associated with the selected asset class category, may be displayed.

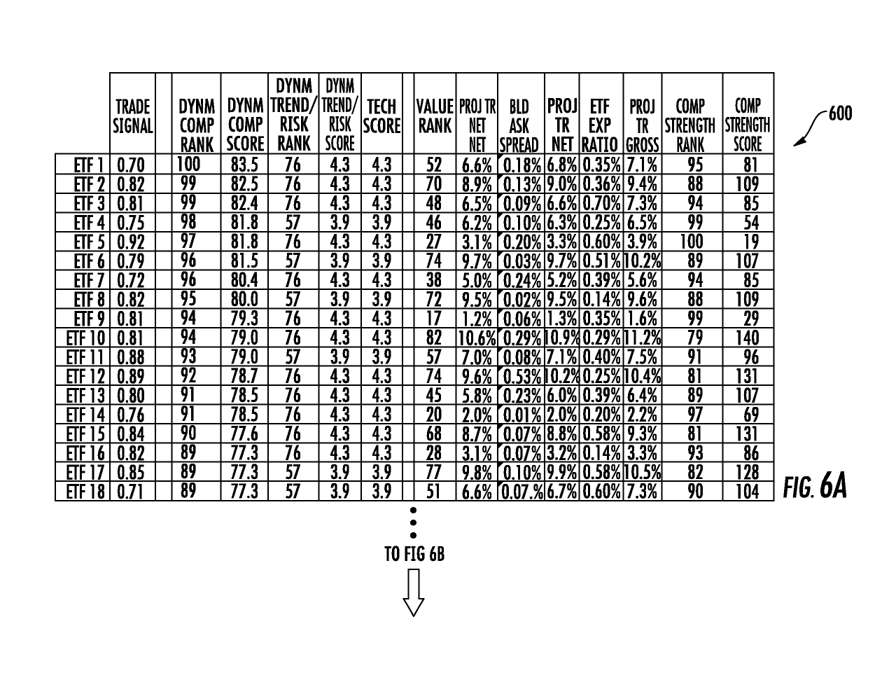

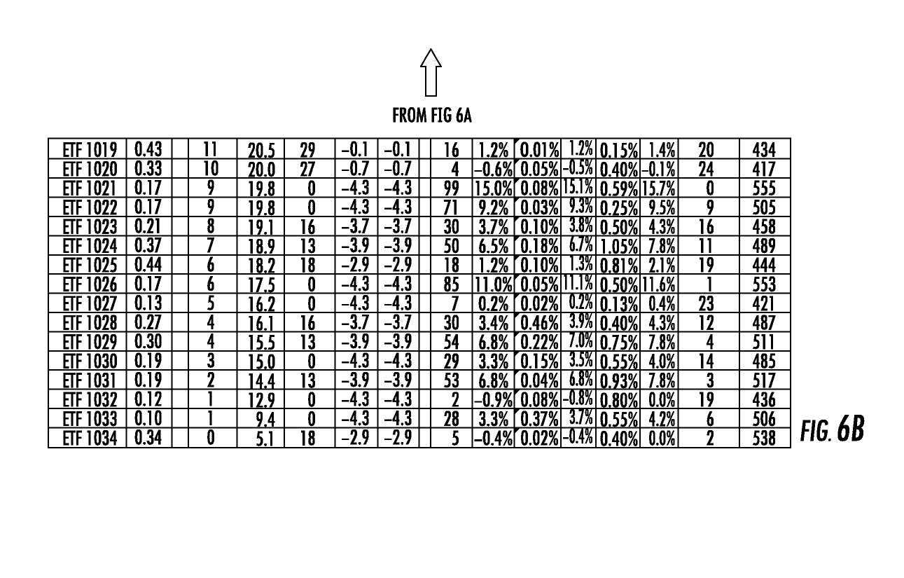

In some embodiments, a graphical user interface that includes all ETFs related to multiple asset classes or asset class categories may be presented for display. The ETFs included in such interface may be based on user selection. Such ETFs may be sorted by their percentile ranking according to one of the multifactor models (e.g., a dynamic model, a tactical model, or a strategic model), and the graphical user interface may include such rankings. In addition to each ETF's percentile ranking with respect to this multifactor model, the graphical user interface may also include percentile rankings with respect to other multifactor models, factor data and/or corresponding rankings of the ETFs based on such factor data. By way of example, FIGS. 6A-6B depict an exemplary graphical user interface 600 that includes all ETFs regardless of asset class or asset class category ranked according to the dynamic multifactor model. Accordingly, the graphical user interface 600 includes the percentile rankings of the ETFs based on the dynamic multifactor model. The graphical user interface 600 may be presented based on user selection (e.g., a user selecting a button for “All Assets—Dynamic”). The graphical user interface 600 also includes the percentile rankings of the ETFs based on value, relative strength, and dynamic trend/risk factors. The graphical user interface 600 also includes additional data, such as the projected rate of total return, bid-offer spread, and expense ratio, regarding the ETFs. Some of this data may be calculated based on retrieved factor data. For example, retrieved factor data may be used to calculate the projected total return of each asset. Thereafter, the projected total returns of multiple constituent holdings may be aggregated to calculate the projected total return of each ETF. In a particular embodiment, each ETF may be further selectable by a user, where selecting a particular ETF results in the display of a further graphical interface that includes the allocation of the ETF's constituent holdings.

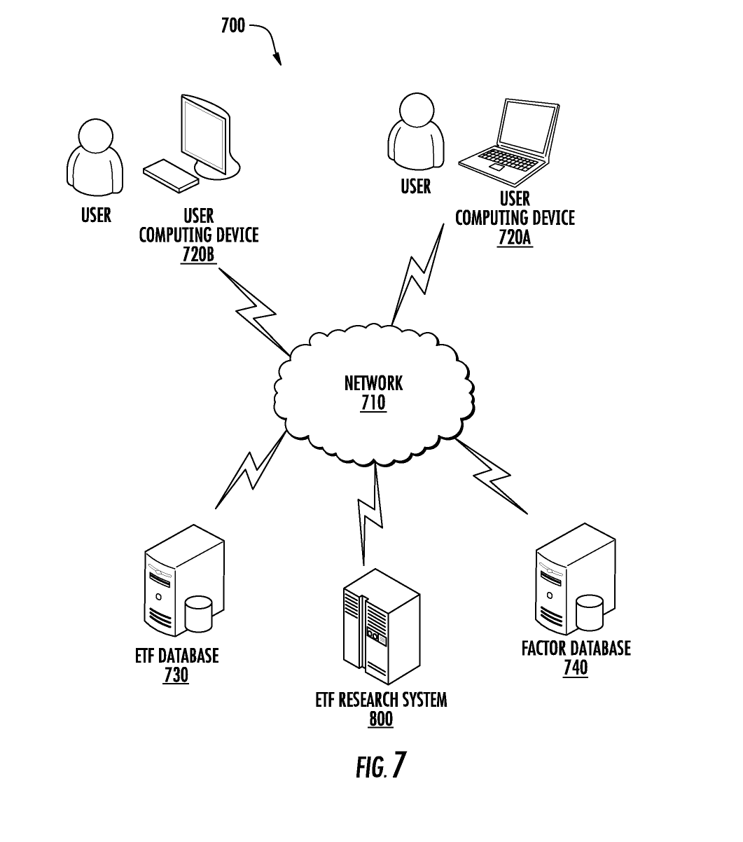

FIG. 7 depicts an operating environment 700 according to one embodiment of the present invention. The operating environment 700 includes an ETF research system 800. In addition, one or more users, each having a user computing device 720, such as a PC, laptop, mobile phone, tablet, television, mobile device, or the like, may be in communication with the ETF research system 800 via a network 710, such as the Internet, wide area network, local area network, Bluetooth network, near field network, or any other form of contact or contactless network. The ETF research system 800 is typically in communication with an ETF database 730 and a factor database 740 via the network 710. In some instances, the ETF research system 800 may be in communication with multiple ETF databases and/or factor databases. The ETF research system 800 may regularly (e.g., daily, weekly, monthly, or quarterly) retrieve information regarding the asset allocation of one or more ETFs from the ETF database 730. The ETF research system 800 may continuously (e.g., every few seconds or minutes) retrieve factor data from the factor database 740 (e.g., receive data from the factor database 740 via a data stream), thereby allowing the ETF research system 800 to continuously update the percentile ranking of ETFs (e.g., in real time).

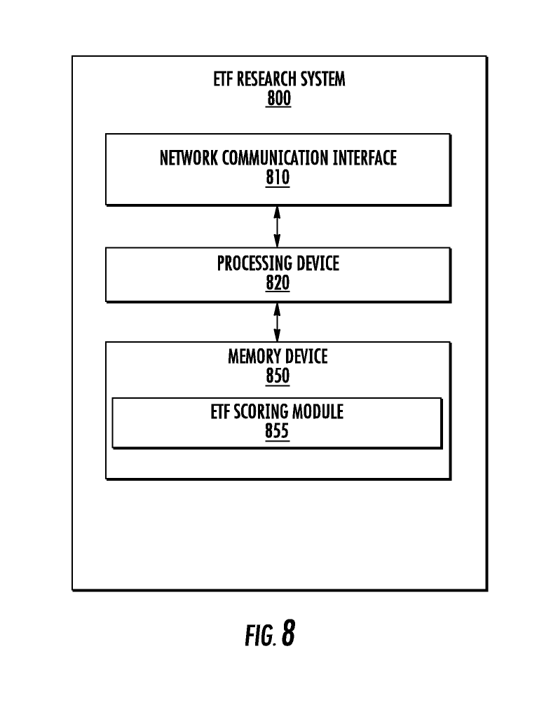

FIG. 8 depicts the ETF research system 800 in more detail. As depicted in FIG. 8 the ETF research system 800 typically includes various features such as a network communication interface 810, a processing device 820, and a memory device 850. The network communication interface 810 includes a device that allows the ETF research system 800 to communicate over the network 710 (shown in FIG. 7) with the user computing devices 720. In this regard, the ETF research system may graphically present (e.g., communicate over the network 710) an interface (e.g., a graphical user interface) to each computing device, which can then be displayed on each user computing device to allow each user to view ETF information and otherwise interact with the ETF research system 800.

As used herein, a “processing device,” such as the processing device 820, generally refers to a device or combination of devices having circuitry used for implementing the communication and/or logic functions of a particular system. For example, a processing device 820 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 820 may further include functionality to operate one or more software programs based on computer-executable program code thereof, which may be stored in a memory. As the phrase is used herein, a processing device 820 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory device,” such as the memory device 850, generally refers to a device or combination of devices that store one or more forms of computer-readable media for storing data and/or computer-executable program code/instructions. Computer-readable media is defined in greater detail below. For example, in one embodiment, the memory device 850 includes any computer memory that provides an actual or virtual space to temporarily or permanently store data and/or commands provided to the processing device 820 when it carries out its functions described herein.

As noted, the ETF research system 800 is configured to score ETFs according to one or more multifactor models and present the scores of the ETFs via one or more user interfaces. Accordingly, the ETF research system 800 typically includes an ETF scoring module 855 stored in the memory device 850, which scores ETFs and presents the scores of the ETFs via one or more user interfaces (e.g., as described with respect to FIGS. 1-6).

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. An ETF research system for scoring a plurality of exchange traded funds according to one or more multifactor model and presenting the scores of the exchange traded funds to a user device via one or more user interfaces, the ETF research system comprising:
a non-transitory computer-readable storage medium;
at least one computer processor; and
an ETF scoring module stored in the memory and executable by the computer processor, the ETF scoring module comprising computer-executable instructions for causing the computer processor to be configured for:
determining the asset allocation of each exchange traded fund, each exchange traded fund holding one or more constituent holdings;
retrieving factor data regarding each constituent holding;
based on the retrieved factor data and the asset allocation for each exchange traded fund, determining a first score of each exchange traded fund according to a first multifactor model;
based on the first score of each exchange traded fund, determining a first percentile ranking of each exchange traded fund relative to the plurality of exchange traded funds;
determining a first percentile ranking for each of a plurality of asset class categories, wherein determining the first percentile ranking for each asset class category comprises determining an average of the first percentile rankings of each exchange traded fund associated with such asset class category; and
graphically presenting a first user interface for display on the user device, the first user interface including a numeric representation and a color representation of the first percentile ranking of one or more of the asset class categories.

2. The ETF research system according to claim 1, wherein the ETF scoring module comprises computer-executable instructions for causing the computer processor to be configured for:
receiving a selection of one of the asset class categories from the user device; and
based on the selection of one of the asset class categories, graphically presenting a second user interface for display on the user device, the second user interface including a numeric representation and a color representation of the first percentile ranking of each exchange traded fund associated with the selected asset class category.

3. The ETF research system according to claim 1, wherein the ETF scoring module comprises computer-executable instructions for causing the computer processor to be configured for:
based on the retrieved factor data and the asset allocation for each exchange traded fund, determining a second score of each exchange traded fund according to a second multifactor model;
based on the second score of each exchange traded fund, determining a second percentile ranking of each exchange traded fund relative to the plurality of exchange traded funds; and
determining a second percentile ranking for each of the plurality of asset class categories, wherein determining the second percentile ranking for each asset class category comprises determining an average of the second percentile rankings of each exchange traded fund associated with such asset class category;
wherein the first user interface includes a numeric representation and a color representation of the second percentile ranking of one or more of the asset class categories.

4. The ETF research system according to claim 1, wherein the ETF scoring module comprises computer-executable instructions for causing the computer processor to be configured for:
receiving a user selection from the user device; and
based on the user selection received from the user device, graphically presenting a second user interface for display on the user device, the second user interface including a numeric representation and a color representation of the first percentile ranking of each exchange traded fund associated with a plurality of asset class categories.

5. The ETF research system according to claim 1, wherein the ETF scoring module comprises computer-executable instructions for causing the computer processor to be configured for:
continuously retrieving updated factor data regarding each constituent holding; and
based on the updated factor data, continuously updating (i) the first score of each exchange traded fund, (ii) the first percentile ranking of each exchange traded fund, and (iii) the first percentile ranking for each asset class category.

6. The ETF research system according to claim 1, wherein the asset class categories included in the first user interface are included in the first user interface based on a user selection received from the user device.

7. A computer program product for scoring a plurality of exchange traded funds according to one or more multifactor model and presenting the scores of the exchange traded funds to a user device via one or more user interfaces, the computer program product comprising a non-transitory computer-readable storage medium having computer-executable instructions for causing a computer processor to be configured for:
determining the asset allocation of each exchange traded fund, each exchange traded fund holding one or more constituent holdings;
retrieving factor data regarding each constituent holding;
based on the retrieved factor data and the asset allocation for each exchange traded fund, determining a first score of each exchange traded fund according to a first multifactor model;
based on the first score of each exchange traded fund, determining a first percentile ranking of each exchange traded fund relative to the plurality of exchange traded funds;
determining a first percentile ranking for each of a plurality of asset class categories, wherein determining the first percentile ranking for each asset class category comprises determining an average of the first percentile rankings of each exchange traded fund associated with such asset class category; and
graphically presenting a first user interface for display on the user device, the first user interface including a numeric representation and a color representation of the first percentile ranking of one or more of the asset class categories.

8. The computer program product according to claim 7, wherein the non-transitory computer-readable storage medium has computer-executable instructions for causing the computer processor to be configured for:
receiving a selection of one of the asset class categories from the user device; and
based on the selection of one of the asset class categories, graphically presenting a second user interface for display on the user device, the second user interface including a numeric representation and a color representation of the first percentile ranking of each exchange traded fund associated with the selected asset class category.

9. The computer program product according to claim 7, wherein the non-transitory computer-readable storage medium has computer-executable instructions for causing the computer processor to be configured for:
based on the retrieved factor data and the asset allocation for each exchange traded fund, determining a second score of each exchange traded fund according to a second multifactor model;
based on the second score of each exchange traded fund, determining a second percentile ranking of each exchange traded fund relative to the plurality of exchange traded funds; and
determining a second percentile ranking for each of the plurality of asset class categories, wherein determining the second percentile ranking for each asset class category comprises determining an average of the second percentile rankings of each exchange traded fund associated with such asset class category;
wherein the first user interface includes a numeric representation and a color representation of the second percentile ranking of one or more of the asset class categories.

10. The computer program product according to claim 7, wherein the non-transitory computer-readable storage medium has computer-executable instructions for causing the computer processor to be configured for:
receiving a user selection from the user device; and
based on the user selection received from the user device, graphically presenting a second user interface for display on the user device, the second user interface including a numeric representation and a color representation of the first percentile ranking of each exchange traded fund associated with a plurality of asset class categories.

11. The computer program product according to claim 7, wherein the non-transitory computer-readable storage medium has computer-executable instructions for causing the computer processor to be configured for:
continuously retrieving updated factor data regarding each constituent holding; and
based on the updated factor data, continuously updating (i) the first score of each exchange traded fund, (ii) the first percentile ranking of each exchange traded fund, and (iii) the first percentile ranking for each asset class category.

12. The ETF research system according to claim 1, wherein the asset class categories included in the first user interface are included in the first user interface based on a user selection received from the user device.

13. A computerized method for scoring a plurality of exchange traded funds according to one or more multifactor model and presenting the scores of the exchange traded funds to a user device via one or more user interfaces, comprising:
determining, via a computer processor, the asset allocation of each exchange traded fund, each exchange traded fund holding one or more constituent holdings;
retrieving, via a computer processor, factor data regarding each constituent holding;
based on the retrieved factor data and the asset allocation for each exchange traded fund, determining, via a computer processor, a first score of each exchange traded fund according to a first multifactor model;
based on the first score of each exchange traded fund, determining, via a computer processor, a first percentile ranking of each exchange traded fund relative to the plurality of exchange traded funds;
determining, via a computer processor, a first percentile ranking for each of a plurality of asset class categories, wherein determining the first percentile ranking for each asset class category comprises determining an average of the first percentile rankings of each exchange traded fund associated with such asset class category; and
graphically presenting, via a computer processor, a first user interface for display on the user device, the first user interface including a numeric representation and a color representation of the first percentile ranking of one or more of the asset class categories.

14. The method according to claim 13, comprising:
receiving a selection of one of the asset class categories from the user device; and
based on the selection of one of the asset class categories, graphically presenting a second user interface for display on the user device, the second user interface including a numeric representation and a color representation of the first percentile ranking of each exchange traded fund associated with the selected asset class category.

15. The method according to claim 13, comprising:
based on the retrieved factor data and the asset allocation for each exchange traded fund, determining a second score of each exchange traded fund according to a second multifactor model;
based on the second score of each exchange traded fund, determining a second percentile ranking of each exchange traded fund relative to the plurality of exchange traded funds; and
determining a second percentile ranking for each of the plurality of asset class categories, wherein determining the second percentile ranking for each asset class category comprises determining an average of the second percentile rankings of each exchange traded fund associated with such asset class category;
wherein the first user interface includes a numeric representation and a color representation of the second percentile ranking of one or more of the asset class categories.

16. The method according to claim 13, comprising:
receiving a user selection from the user device; and
based on the user selection received from the user device, graphically presenting a second user interface for display on the user device, the second user interface including a numeric representation and a color representation of the first percentile ranking of each exchange traded fund associated with a plurality of asset class categories.

17. The method according to claim 13, comprising:
continuously retrieving updated factor data regarding each constituent holding; and
based on the updated factor data, continuously updating (i) the first score of each exchange traded fund, (ii) the first percentile ranking of each exchange traded fund, and (iii) the first percentile ranking for each asset class category.

18. The method according to claim 13, wherein the asset class categories included in the first user interface are included in the first user interface based on a user selection received from the user device.
